(19) United States
(12) Patent Application Publication
(10) Pub. No.: US 2011/0249000 A1
(43) Pub. Date: Oct. 13, 2011

(54) Control Module for a Field Device

(76) Inventors: Andreas Isenmann, Haslach (DE); Volker Allgaier, Haslach i.K. (DE)

(21) Appl. No.: 12/902,431

(22) Filed: Oct. 12, 2010

Related U.S. Application Data
(60) Provisional application No. 61/256,032, filed on Oct. 29, 2009.

(30) Foreign Application Priority Data
Oct. 29, 2009 (EP) 09 174 497.9

(51) Int. Cl. G05B 23/02; G06T 3/00

(52) U.S. Cl. 345/428; 345/501; 345/440

(57) ABSTRACT

A control module of a field device includes an image processing module that is able to generate an image from process data of the field device, which process data are present in numerical form, which image can be displayed by a corresponding image display unit, for example the display of a PDA, in such a manner that a person can directly interpret the process data.

### REFERENCE TO RELATED APPLICATIONS

This application claims the benefit of the filing date of EP Patent Application Serial No. EP 09 174 497.9 filed 29 Oct. 2009, the disclosure of which is hereby incorporated herein by reference and of U.S. Provisional Patent Application Ser. No. 61/256,032 filed 29 Oct. 2009 the disclosure of which is hereby incorporated by reference.

### TECHNICAL FIELD

This invention relates to the field of process control and process monitoring. In particular, the invention relates to a control module for a field device, to the field device, to a process monitoring system, to a method for controlling a field device, to a program element and to a computer-readable medium.

### BACKGROUND INFORMATION

Process monitoring systems and process control systems, which are used for monitoring and/or controlling technical installations, for example in such various fields as foodstuffs technology, the preparation of crude oil or the manufacture of plastics, as a rule comprise a multitude of field devices. The field devices can on the one hand be equipped for measuring various process variables such as a filling level, limit level, pressure, flow, or temperature; and on the other hand they can also be used to forward and process the measured data, for example to a central monitoring unit. In this arrangement the field devices for measuring process variables are, as a rule, arranged in close proximity to the components of the technical installation, which components are to be monitored, for example a tank whose filling level is to be determined, or a line whose through flow is to be measured. Further field devices that are connected to the measuring field devices for communicating by way of lines or other media, for example wirelessly, can be arranged at any other locations on the technical installation.

Furthermore, it is also possible for the field devices not to be connected to a central monitoring system, but instead for a field device to be connected to a further field device in the form of an actuator, which can, for example, set a control member of the technical installation by way of the measured values determined by the field device. In particular, in such measuring devices remote diagnosis or remote maintenance can often prove to be difficult or even impossible.

During maintenance of the field devices, for example if an error has occurred within a field device or if the field device is to be checked for error-free functioning, frequently a service technician reads process data from a field device by way of which s/he can interpret the functional status of the respective field device. For example, by means of an echo curve of a radar-operated filling-level measuring device a service technician can determine whether the radar sensor and the processing electronics function correctly.

In order to be able to interpret and visualise the process data read from a field device, a service technician normally requires a special evaluation unit, for example a portable computer on which special software is installed. For example, if data that is transmitted in the form of numeric values from the field device to the evaluation unit is to be graphically processed, it is helpful if the evaluation unit has knowledge of the significance of these numeric values. Therefore, as a rule, special software is required to visualise this data. This software must, in certain circumstances, also be made available to various field devices and various evaluation units.

The requirements of software that can be installed on a laptop differ from the requirements specified, for example, for software installed on a mobile telephone or a PDA (personal digital assistant).

If there is a change in the design or in the configuration of the field device or in the significance of the process data provided by a field device, or if reading-out the numerical values is to take place with a device in relation to which no specially adapted read-out software exists as yet, this can result in very considerable maintenance expenditure in relation to the read-out software.

### SUMMARY OF THE INVENTION

One aspect of the invention relates to a control module for a field device.

A control module for a field device can be a device that is connected to a measuring device of the field device or that is arranged in the housing of the field device, and/or that is designed to control the field device, or optionally to receive data from the measuring device, or to control the measuring device. For example, the control module can comprise one or several printed circuit boards with integrated circuits arranged thereon. Furthermore, the control module can be mechanically connected to the measuring device, or it can be integrated in the housing of the measuring device. However, it is also possible for the control module to comprise a housing of its own and to be arranged so as to be spatially set apart from the measuring device. In this case the control module can comprise a communication line for data communication with the measuring device.

This may reduce the costs and effort required for the maintenance of field devices.

A field device can be any type of device that forms part of a process monitoring system. For example, a field device can be used for acquiring process variables such as the filling level, limit level, pressure or temperature, for example for acquiring a filling level or a limit level in a tank, or a flow through a line. Moreover, there are also field devices that are designed to transmit or receive these process variables, or that further process these process variables, or field devices that are designed to control actuators, for example regulators or valves, of the process control system in order to in this way control the technical plant monitored and controlled by the process monitoring system.

According to one embodiment of the invention, the control module comprises an image processing module, wherein the image processing module is designed to generate image data from process data of the field device. In other words, the control module comprises an image processing module that is in a position from the process data that is present in numerical form to generate an image that can be displayed by a corresponding image display unit in such a manner that a person can directly interpret the data.

For example, for this purpose the image processing module comprises additional information as to how the process data of the field device is to be interpreted, visualised or presented. The process data can thus be pure numerical values, and the image data can be data that contains information about how graphics are to be presented, for example pixel information or vectors of vector graphics.

Furthermore, it is also possible for (raw) image data that already exists in the image processing module to be enriched with the process data. For example, in the image processing module the image of a blank diagram is already present, which is joined by the image processing module with a graphic or a curve, which are parameterised by the process data. In other words, the image processing module is designed to encode process data of the field device to image data or to convert the aforesaid to image data. It is then possible for the process data to no longer be present in the image data in a form that can be interpreted particularly well by a machine, but instead to be present in a form that can easily be displayed by a display device and that is better accessible to human interpretation.

In an exemplary embodiment of the invention the control module comprises a transmitting module, wherein the transmitting module is designed to send the image data. Overall, the control module of the field device is thus designed to generate image data from the process data of the field device, which image data can be displayed by a corresponding display device without knowledge of the significance of the process data or its format.

According to one embodiment of the invention, the process data comprise a measurement value, an echo curve and/or diagnostic data of the field device or of the measuring device connected to the field device. For example, the control module can comprise a measurement module that is designed to control the measuring device. By way of this measurement module the control module can receive a measurement value or raw measurement data from the measuring device, from which data the actual measurement value is then calculated by the measurement module. For example, the measurement module of a filling-level measuring device, which operates on the basis of radar echoes or ultrasound echoes, can receive the values of an echo curve from the measuring device, which values represent the raw measurement values, and from this echo curve can calculate a filling level, for example in a tank, which filling level then represents the measurement value of the field device. Furthermore, the control module and also the measuring device can, as a rule, deliver various diagnostic data that can be converted to image data by the image processing module.

According to one embodiment of the invention, the image processing module is designed to generate the image data in a standard format or to convert the image data to a standard format. It is thus sufficient for the receiving device that receives the image data to present a graphic that has been generated in a standard format, for example JPG, BMP, TIFF, GIF or PNG. In many receiving devices this ability is already included in the range of standard functions.

According to one embodiment of the invention, the image processing module is designed to generate a diagram from process data. In other words, the image data can comprise a diagram that can, for example, comprise the graphic display of values by means of a bar chart, a graph and/or a curve. As already mentioned, to this effect in the image processing module a blank diagram can already be stored, i.e. for example a diagram in which only the axes and optionally their labelling is present, which blank diagram is then enriched by, or joined with, a diagram that is parameterised by specific process data.

In particular, it may be possible for the image processing module to generate a graphic in the form of a measurement value curve, for example an echo curve of a filling-level measuring device.

According to one embodiment of the invention, the image processing module is designed to generate a graphic from process data, which graphic represents a table. In other words, the image data comprises a table. In other words, the image data need not necessarily comprise a graphic, instead it can also comprise a table that is encoded as a graphic. For example, the image data does not comprise process data as numerical values, but instead as pixels that represent these numerical values. It is thus possible for a display device that is able to process image data and to display said image data to represent the aforesaid particularly easily without additional information on a display device.

Furthermore, the image processing module may comprise further additional information that allows better interpretation of the values in the table, for example column labels and line labels.

In other words, the image processing module does not generate a data table, but instead an image of the table.

According to one embodiment of the invention, the image processing module is designed to generate image data at a resolution that is optimised for a receiving device. In this arrangement in the case of image data comprising pixels, the term “resolution” can refer to the number of pixels in the image data.

It is possible for the control device to generate image data in different sizes, i.e. resolutions, depending on the receiving device and/or the message to be sent. Thus, image data that is, for example, sent to a computer by e-mail can comprise a typical size of 1024×768 pixels, which corresponds to a commonly used resolution. However, the control device can also generate image data of a lower resolution, for example for sending via MMS, which image data, for example, comprises a size of only 300×200 pixels. The following might be reasons for generating image data in various sizes: on the one hand, the size of the image data may already be adapted to the size of a display of the receiving device; on the other hand, smaller image data can be sent more quickly and/or economically.

According to one embodiment of the invention, the image processing module is designed to generate image data at different resolutions.

According to one embodiment of the invention, the transmitting module comprises an internet client. For example, it is possible for the field device to be able to communicate with other field devices and with a receiving device by way of the internet protocol. By means of the internet client of the transmitting module it is then possible to transmit to the other field devices not only the image data but also the process data, for example the raw measurement data, the diagnostic data and the measurement value of the field device.

According to one embodiment of the invention, the transmitting module is designed to encode the image data in an e-mail, wherein the transmitting module is designed to send the e-mail. For example, the image data can be appended to the e-mail as an appendix. In this case it is, for example, possible for a specific e-mail address to be predetermined in the control module or in the transmitting module, to which e-mail address the e-mail is to be sent. In this way it is possible, for example, to send at regular intervals the images generated by the image processing module to a particular e-mail receiver.

According to one embodiment of the invention, the transmitting module comprises a transmitter for a mobile radio network. The transmitting module can comprise a mobile telephone that is, for example, integrated in the control module. For example, the control module can comprise a radio module with a SIM card that like a normal mobile radio device can communicate with other subscribers of the mobile radio network. These days most mobile radio networks also permit transmission of digital data. Furthermore, it is possible to establish an internet connection by way of the mobile radio network. Moreover, beyond this possibility there are still further possibilities for transmitting data by way of mobile radio networks.

According to one embodiment of the invention, the transmitting module is designed to encode the image data in a message, wherein the transmitting module is designed to send the message. Such a message can, for example, be a so-called multimedia messaging service (MMS). In other words, the image or the image data can be encoded in the MMS or can be implemented as an appendix of the MMS.

It may thus be possible for the control device, or for the field device by means of the control device, from process data that is to be sent to first generate a graphic, for example in a standard format such as JPG, BMP, TIFF, GIF or PNG, before sending this graphic as an e-mail or MMS to a recipient. The recipient or the receiving device can, for example, be a laptop (mobile computer), a PDA or a mobile telephone of a service technician who calls up the process data by means of the corresponding graphic from the field device. For example, the measurement-value storage device present in the sensor can be converted to a measurement value curve, or the echo curve of the field device can be sent as a graphic directly to a mobile telephone, where it can be visualised without additional software if the generated graphic comprises a standard format that can be processed by the software of the mobile telephone.

According to one embodiment of the invention, the control module is designed to generate and transmit the image data upon request from a receiving device. With this so-called pull operation, e.g. upon request per e-mail or per MMS, from a computer or generally from a receiving device, e.g. a PDA or a mobile telephone, the image data are generated upon request.

For example, the field device or the control module can comprise an e-mail address, and a service technician can transmit an e-mail message by way of his/her laptop to the control module or to the field device with this e-mail address, wherein in the e-mail a special graphic, for example predetermined diagnostic data or a predetermined measurement value curve, is queried. Upon receipt of the e-mail the control module evaluates the e-mail, for example the e-mail can comprise a particular command that can be interpreted by the control module, and subsequently in reaction to the query by e-mail generates the desired image data and transmits it by e-mail to the e-mail address from which the query was transmitted.

Analogously a query by way of a PDA or a mobile telephone may also be possible, wherein an SMS or MMS with the query to the control module is transmitted from the PDA or from the mobile telephone. This SMS or MMS can then also be evaluated by the control module, and the desired generated image data can then be transmitted back to the sender of the SMS or MMS, for example to the subscriber number or telephone number of the sender.

According to one embodiment of the invention, the control module is designed to generate and transmit the image data after the occurrence of an internal event in the field device. In this so-called push operation of the control module the image data is automatically generated and transmitted when a predetermined internal event occurs.

To this effect it may be possible, for example, for the control module to comprise a table stating the internal events to which a particular type of graphic is to be transmitted to a particular list of message receivers (for example a list of e-mail addresses and/or telephone numbers). In this context the term “internal events” can refer to predetermined times at which, for example, a timer or a clock module of the control module triggers an event. However, internal events can also be triggered in that, for example, a new measurement value has been picked up; a measurement value has been picked up that differs from the previous measurement value; a predetermined measurement value has been reached; or, for example, an error has occurred in the control module or in a measuring device, i.e. predetermined diagnostic data has assumed predetermined values.

According to one embodiment of the invention, the image processing module is also designed to generate image data in various formats. For example, the image processing module can not only generate images of one standard format, but it can also generate various standard formats. For example, an e-mail or an MMS message could not only comprise one image in one format, but instead in a multitude of formats in order to ensure that the receiving device can at least represent one of the images.

According to one embodiment of the invention, the control module is designed to select a format for the image data. Selection of the format can then, for example, take place by means of presetting the control module or by way of the requirement of the receiving device for a particular graphic.

A further aspect of the invention relates to a field device.

According to one embodiment of the invention, the field device comprises a control module as described in the preceding and in the following text.

According to one embodiment of the invention, the field device comprises a control module that is designed to receive process data from a measuring device. This measuring device can form part of the field device, but for data communication it can also be connected to the field device or to the control module. In this context the term “process data” can relate to raw measurement data, for example radar echo data, pre-processed measurement data or diagnostic data of the field device and of the measuring device. The control module can also be the control module of a measuring device and can, for example, be arranged together with the measuring device in a shared housing.

For example, the measuring device is a filling level radar, for example for determining the filling level of a tank.

A further aspect of the invention relates to a process monitoring system.

According to one embodiment of the invention, the process monitoring system comprises a field device as described in the preceding and in the following text.

According to one embodiment of the invention, the process monitoring system comprises a communication network and a receiving device with a display device, wherein the field device is designed to transmit the image data by way of the communication network to the receiving device, and the receiving device is designed to receive the image data by way of the communication network and to display it on the display device.

In this arrangement the communication network can be a cable-bound communication network or a wireless network. For example the interne, an Ethernet connection, a field bus system, a mobile radio network and similar communication networks could be considered.

As already mentioned, the receiving device can be a computer, for example a laptop, or a portable device such as a mobile telephone or a PDA. The display device can be a monitor screen or an integrated display, for example an LCD screen.

For communication and identification within the communication network the field device and the receiving device can comprise corresponding identification addresses, for example an IP address, an e-mail address, a subscriber number (telephone number). Overall, the communication network can be used for the entire communication between the field device and the receiving device. This means that on the one hand the queries of the receiving device are transmitted to the field device by way of the communication network; and conversely that the messages with the image data are sent back or sent to the receiving device by the field device.

According to one embodiment of the invention, the receiving device is designed to receive and process the image data with standard functions.

In this context the term “standard functions” can relate to functions or programs that have not been matched to the field device or that are already present on the device in the standard functions package. For example, computers, PDAs, mobile telephones, laptops and similar devices as a rule comprise a pre-installed e-mail client, image display programs and usually also MMS receiving modules if they are designed to communicate by way of a mobile radio network.

A further aspect of the invention relates to a method for controlling a field device.

It is to be understood that the method-related steps described in the preceding and in the following text, which method-relates steps were described with reference to the control module, the field device or the process monitoring system, can be embodiments of the method. Conversely it is also possible for the control module, the field device and/or the process monitoring system to be designed to carry out the method-related steps described in the preceding and in the following text.

According to one embodiment of the invention, the method comprises the steps of: generating image data from process data of the field device with a control module of the field device; transmitting the image data to a receiving device.

According to one embodiment of the invention, the method also comprises one or several of the following steps: receiving measurement data from a measuring device; generating process data, for example processing or calculating the measurement data from raw data, calling up diagnostic data; receiving a request for image data; generating image data after triggering an internal event in the control module or field device.

According to one embodiment of the invention, process data such as measurement values, echo curves or other diagnostic data can be sent by a field device, which process data can be presented in a receiving device or target system without a requirement for processing by standard display methods.

Furthermore, it is possible for process data arising in a field device to also be able to be digitally transmitted to a receiving device or target system. In this arrangement the values are, for example, transmitted as a multitude of floating point numbers. These floating point numbers are then prepared in receiving devices that are aware of the content of the floating point numbers, for example in order to graphically present the data. However, if data is already graphically processed by the field device, for the purpose of visualisation the receiving device does not require any information about the type of data.

Further aspects of the invention relate to a program element and a computer-readable medium on which the program element is stored.

The program element or the computer program is designed to instruct one or several processors to carry out the steps of the method for controlling a field device in a manner as described in the preceding and in the following text.

For example, the field device can comprise a processor on which among other things the operating system of the field device is executed. In this arrangement the program element can be a software module that is stored in the field device and that can be executed by the processor of the field device.

Furthermore, as a rule, the receiving device may comprise a further processor, which, for example, executes the operating system of the receiving device and that is suitable for carrying out further standard functions or for executing standard software modules stored in the receiving device, which functions or modules relate to the receiving, transmitting and processing of the image data.

Overall it should be understood that the described modules, for example the control module, the transmitting module, a receiving module of the receiving device, the measurement module and/or the image processing module can be implemented as programmed software modules or functions. However, it is also possible for these functional modules to be partly or fully implemented as hardware.

In the computer-readable medium or computer program product a program element is stored which, when executed on one or several processors, instructs the processor or processors to carry out the steps of the method for controlling the field device as described in the preceding and in the following text.

In this arrangement the term “computer-readable medium” can refer to a diskette, a hard disc, a USB storage device, a RAM, a ROM or an EPROM. The term “computer-readable medium” can also refer to a data communication network, for example the internet, which makes it possible to download a program code.

Below, exemplary embodiments of the invention are described in detail with reference to the enclosed figures.

### BRIEF DESCRIPTION OF THE FIGURES

FIG. 1 diagrammatically shows a process monitoring system according to an exemplary embodiment of the invention.

FIG. 2 diagrammatically shows a process monitoring system according to an exemplary embodiment of the invention.

FIG. 3 shows a graphic in the form of a diagram.

FIG. 4 shows a graphic in the form of a table.

FIG. 5 shows a flow chart for a control method according to an exemplary embodiment of the invention.

The reference characters used in the figures and their significance are provided in the list of reference characters. Basically, identical or similar components have the same reference characters.

### DETAILED DESCRIPTION OF EXEMPLARY EMBODIMENTS

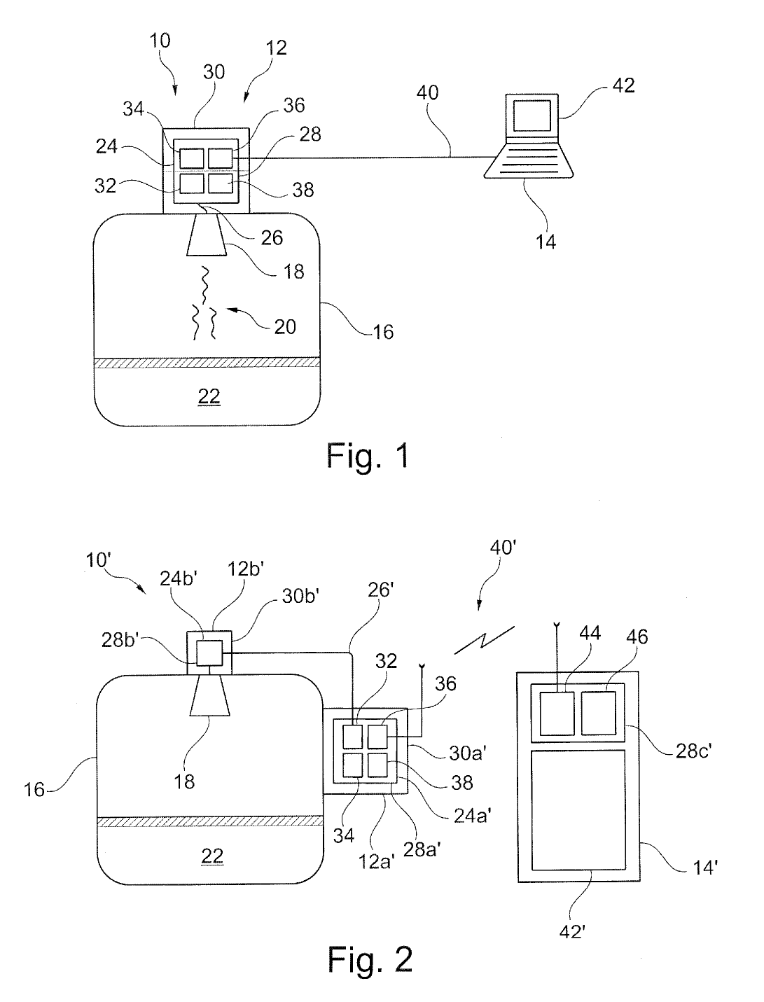

FIG. 1 diagrammatically shows an exemplary embodiment of a process monitoring system 10 with a field device 12 and a receiving device 14 in the form of a computer 14. The process monitoring system 10 is used for monitoring a technical installation with a tank 16. The field device 12 is used for monitoring the filling level of a liquid 22 in the tank 16. To this effect the field device 12 comprises a filling level radar or a measuring device 18 that emits radar rays 20 that are reflected by the surface of the liquid 22 and again reach the filling level radar 18 as a radar echo 20, whereupon they are evaluated by the field device 12.

To this effect the filling level radar 18 is connected to a control module 24 of the field device 12 by way of a communication line 26. The control module 24, which can, for example, be a printed circuit board 24 in a housing 30 of the field device 12, comprises a processor 28 on which a multitude of modules 32, 34, 36, 38 can be executed. However, it is also possible for the modules 32 to 38 to be implemented as hardware or to be executed on one processor or on various processors of the field device 12.

The control module 24 comprises a measurement module 32 that can communicate with the filling level radar 18 by way of the communication line 26 in order to control the filling level radar 18 and query measurement data from it. The control module 32 is designed to receive an echo curve of the radar echo 20 by way of the communication line 26 and from it, by way of run-time determination, determine the current filling level in the tank 16 as a measurement value.

Furthermore, the control module 24 comprises a diagnostic module 38 that is designed to carry out self-tests of the control module 24 and also to monitor the function of the filling level radar 18. To this effect the diagnostic module 38 collects diagnostic data.

Furthermore, the control module 24 comprises an image processing module 34 that is in a position, from process data arising in the field device 12, for example raw measurement data, an echo curve, the measurement values calculated by the measurement module 32, or the diagnostic data of the diagnostic module 38, to encode a graphic or to generate a graphic from this data.

Furthermore, the control module 24 comprises a transmitting module 36 that can communicate with the receiving device 14 by way of the line 40 or the communication network 40. For example, the transmitting module 36 comprises an internet client with an e-mail client. The transmitting module 36 can then encode the image data generated by the image processing module 34 as a file to the appendix of an e-mail, or can generate an e-mail with the image data of the image processing module 34 as an appendix, and then transmit this e-mail to the computer 14 by way of the internet 40. On the computer 14 standard software is installed that is able to receive the e-mail, to unpack the appendix of the e-mail, and to store the image data stored therein in the form of a file on the computer 14 and to display it on the display 42 of the computer 14.

FIG. 2 diagrammatically shows a further exemplary embodiment of a process monitoring system 10′. The process monitoring system 10′ comprises a field device 12a′ that is connected by way of a communication line 26′, for example a field bus 26′, to a further, second, field device 12b′. The field device 12b′ comprises a filling level radar 18 that monitors the filling level of a liquid 22 in a tank 16 in the same manner as does the filling level radar 18 from FIG. 1. The field device 12b′ comprises a control module 24b′ that is designed to control the filling level radar 18. The field device 12a′, which can be designed in a manner identical to that of the field device 12, which can, however, be configured differently in the arrangement shown in FIG. 2, comprises a control module 24a′ which with its measurement module 32′ by way of the communication line 26′ can control the control module 24b′ of the field device 12b′ and can also receive raw measurement data and derived measurement data calculated therefrom from the field device 12b′.

Just like the field device 12 from FIG. 1, the field device 12a′ or its control module 24a′ comprises an image processing module 34, a diagnostic module 38 and a transmitting module 36.

The transmitting module 36 comprises a mobile telephone which by way of a mobile radio network 40′ can communicate with a receiving device 14′ in the form of a mobile telephone 14′. When the image processing module 34 has generated a graphic or image data with process data of the field device 12a′, the transmitting module 36 encodes this image data to an MMS and transmits the latter to the mobile telephone 14′. The mobile telephone 14′ comprises standard software in the form of a receiving module 44 that is designed to receive an MMS by way of the radio network 40′ and in the form of a display module 46′ that is designed to interpret the image data generated by the field device 12a′ and to display it on a display 42′ of the mobile telephone 14′.

In the arrangement shown in FIG. 2 the field device 12a′ comprises a control module 24a′ that is arranged in a housing 30a spatially removed from a housing 30b′ of the field device 12b′. Furthermore, the field device 12a′ comprises a processor 28a′ of the control module 24a′, the field device 12b′ comprises a processor 28b′ of the field device 12b′, and the mobile telephone 14′ comprises a further processor 28e, which are suitable for executing the respective modules installed on the device.

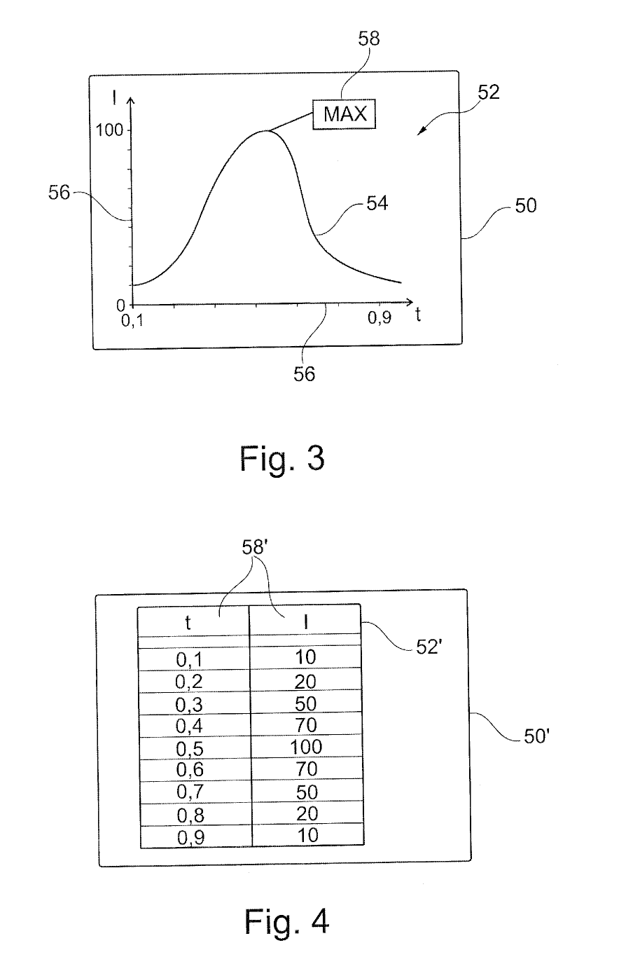

FIG. 3 shows a graphic 50 with a diagram 52 as can be generated by the image processing module 34. It should be understood that the image processing module 34 does not generate graphics 50 that can be viewed by persons, but instead that the image processing module 34 generates digital image files, for example in the form of a file, which can then be interpreted by a display module 46 and displayed by a display 42, 42′ so that the graphic 50 becomes visible to a person. In this arrangement the image data can, for example, be stored in the JPG, BMP, TIFF, GIF or PNG format.

The diagram 52 comprises a radar echo curve 54 and further additional information, such as two axes 56 that comprise a scale and a label 58. This additional information, which can also be used to interpret the radar echo curve 54, is also stored in the image processing module 34.

FIG. 4 shows a further graphic 50′ that can be generated by the image processing module 34. The graphic 50′ comprises a table 52′ which can, for example, comprise part of the values of the radar echo curve 54 from FIG. 3. In this arrangement, apart from the numerical values, the table 52 comprises additional elements, for example dividing lines and column labels 58′.

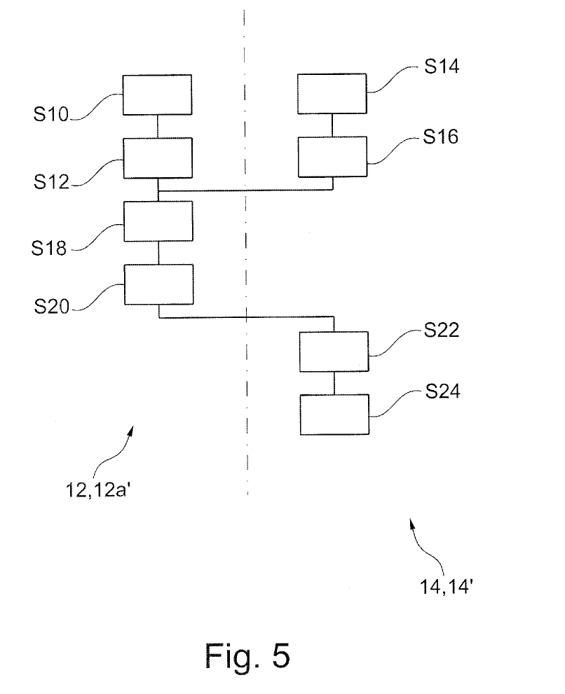

FIG. 5 shows a flow chart relating to a method that can be implemented by a field device 12 or 12a′ together with a receiving device 14 or 14′. In this arrangement the process-related steps on the left-hand side of the diagram are carried out by the field device 12 or 12a′, while the process-related steps on the right-hand side of the diagram are carried out by the receiving device 14 or 14′.

In a step S10 an internal event occurs in the field device 12, 12a′. For example, an error could have occurred in the device 18 or in the field device 12b′; the diagnostic module 38 could have determined diagnostic data that exceeds a determined threshold value; or a timer within the field device 12, 12a′ could have elapsed or a defined time could have been reached.

If an internal event has occurred that triggers renewed measurement, in an optional step S12 the field device 12, 12a′ can instruct the measuring device 18 to determine raw measurement data or to calculate a measurement value.

After an internal event has been triggered which is to cause image data to be generated, the image processing module 34 determines the process data required for generating the corresponding graphic, and together with the additional data that is present in the image processing module 34 generates image data. In this arrangement it is possible for the image processing module 34 to also generate several graphics, for example the graphic from FIG. 3 in several standard formats, and/or the graphic of FIG. 4 in these standard formats.

As an alternative or in addition it is not only an internal event of the field device that can trigger generating image data, but also an external event such as a query by a receiving device 14 or 14′.

To this effect it is possible, for example, for a user of the computer 14 or of the mobile telephone 14′ to generate a query to the field device 12, 12a′. In this context it is imaginable for a computer 14 to independently generate this e-mail, for example if an internal event has occurred in the computer 14; for a user to send an e-mail with a code to the field device 12, 12a′; or for a user of the mobile telephone 14′ to send an SMS with a corresponding code to the field device 12, 12a′.

In a step S16 the receiving device 14, 14′ with a transmitting/receiving module 44 transmits the e-mail or the SMS or generally a message with the query to the field device 12, 12a′ which in turn receives this message with a transmitting/receiving module 32.

As a reaction to the query, analogous to the reaction to an internal event, the field device 12, 12a′ then generates the image data in step S18.

When the image data has been generated, it is encoded in an MMS or an e-mail. The field device 12, 12a′ then transmits this message to the receiving device 14, 14′. In the case of an internal event this can take place in that the field device 12, 12a′ stores information as to the receiving device 14, 14′ to which the corresponding message is to be transmitted. In the case of an external event or a query this can take place in that the field device 12, 12a′ determines the sender of the e-mail (for example by way of the sender's e-mail address) or of the MMS (for example by way of the sender's telephone number) and then sends the message with the image data to the corresponding e-mail address or telephone number.

In a step S22 the receiving device 14, 14′ receives the message and unpacks it. The image data stored can then be stored as a file, for example by means of an e-mail client or by means of the corresponding standard software, in a standard format on a video telephone, wherein said image data in a step S24 can then be displayed on a monitor screen 42 or on a display 42 by the corresponding display software 46.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### LIST OF REFERENCE CHARACTERS

10 Process monitoring system
12 Field device
14 Receiving device (computer)
16 Tank
18 Filling level radar
20 Radar rays
22 Liquid
24 Control module
26 Communication line
28 Processor
30 Housing
32 Measurement module
34 Image processing module
36 Transmitting module
38 Diagnostic module
40 Data line (network)
42 Monitor screen
10′ Process monitoring system
12a′ Field device
12b′ Field device
14′ Mobile telephone
24a′ Control module
24b′ Control module
26′ Field bus
28a′ Processor
28b′ Processor
28c′ Processor
30a′ Housing
30b′ Housing
40′ Radio network
42′ Display
44 Receiving module
46 Display module
50 Graphic
52 Diagram
54 Radar echo curve
56 Axes
58 Label
50′ Graphic
52′ Table
58′ Lettering

1. A control module for a field device, comprising:
an image processing module designed to generate image data from process data of the field device; and
a transmitting module designed to send the image data.

2. The control module of claim 1, wherein the process data comprises at least one of a measurement value, an echo curve, and diagnostic data.

3. The control module according to claim 1, wherein the image processing module is designed to generate the image data in a standard format.

4. The control module according to claim 1, wherein the image processing module is designed to generate a diagram from the process data.

5. The control module according to claim 1, wherein the image processing module is designed to generate a graphic from the process data that represents a table.

6. The control module according to claim 1, wherein the image processing module is designed to generate image data at a resolution that is optimised for a receiving device.

7. The control module according to claim 1, wherein the transmitting module comprises an internet client, the transmitting module being designed to encode the image data to an e-mail and to send the e-mail.

8. The control module according to claim 1, wherein the transmitting module comprises a transmitter for a mobile radio network, the transmitting module being designed to encode the image data to a message and to send the message.

9. The control module according to claim 1, wherein the control module is designed to generate and transmit the image data upon request from a receiving device.

10. The control module according to claim 1, wherein the control module is designed to generate and transmit the image data after the occurrence of an internal event in the field device.

11. A field device, comprising:
a control module including (a) an image processing module designed to generate image data from process data of the field device and (b) a transmitting module designed to send the image data, the control module being designed to receive process data from a measuring device.

12. A process monitoring system, comprising:
a field device including a control module, the control module having (a) an image processing module designed to generate image data from process data of the field device and (b) a transmitting module designed to send the image data, the control module being designed to receive process data from a measuring device;
a communication network; and
a receiving device including a display device,
wherein the field device is designed to transmit the image data via the communication network to the receiving device, and
wherein the receiving device is designed to receive the image data by way of the communication network and to display it on the display device.

13. A method for controlling a field device, comprising the steps of:
generating image data from process data of the field device with a control module of the field device; and
transmitting the image data to a receiving device.

14. A program element which when executed on a processor instructs the processor to carry out the following steps:
generating image data from process data of the field device with a control module of the field device; and
transmitting the image data to a receiving device

15. A computer-readable medium on which a program element is stored which, when executed on a processor, instructs the processor to carry out the following steps:
generating image data from process data of the field device with a control module of the field device; and
transmitting the image data to a receiving device
